(19) United States
(12) Patent Application Publication
(10) Pub. No.: US 2016/0230947 A1
(43) Pub. Date: Aug. 11, 2016

(54) LIGHT FIXTURE FOR MOUNTING TO A CEILING

(71) Applicant: ECLAIRAGE CONTRASTE M.L. INC., SAINT-JEAN-CHRYSOSTOME (CA)

(72) Inventor: STEVE BILODEAU, SAINT-JEAN-CHRYSOSTOME (CA)

(21) Appl. No.: 15/018,150

(22) Filed: Feb. 8, 2016

Related U.S. Application Data
(60) Provisional application No. 62/113,588, filed on Feb. 9, 2015.

(51) Int. Cl. F21S 8/02; F21V 17/10; F16M 13/02

(52) U.S. Cl. CPC F21S 8/026; F16M 13/02; F21V 17/10

(57) ABSTRACT

A light fixture housing and a hook for mounting the light fixture, sidewalls of the housing comprising first and second apertures, the hook comprising a first end part extending at a first angle relative to a main body and a second side part extending at a second angle relative to the main body; the hook being inserted into the housing from the inside by inserting the first end part through one first aperture and the second end part within one second aperture, the second aperture being separated from the first aperture by the length of the main body, a free end of the first end part bearing on the rear surface of the opening and a free end of the second end part bearing against an inner surface of the sidewalls within the housing

### CROSS REFERENCE TO RELATED APPLICATIONS

This application claims benefit of U.S. provisional application Ser. No. 62/113,588, filed on Feb. 9, 2015. All documents above are incorporated herein in their entirety by reference.

### FIELD OF THE INVENTION

The present invention relates to light fixture for mounting to a ceiling, a wall or the like.

### BACKGROUND OF THE INVENTION

There are various fastening devices to mount a light fixture to a ceiling or the like. With such light fixtures in the form of a pot for example and using a spring arrangement, the fixing is accomplished inside the hole. Other systems require a metallic plate inside the ceiling, which results in an electrician to work inside the ceiling to carry out the mounting operation. Other devices require the provision of a lath to which the housing is fixed.

It has been found that, in most cases, to secure the housing to the ceiling often causes some damage to the material of the ceiling or delays are often encountered due to the need to handle the different pieces of the light fixture.

Therefore, there is a need in the art for a mounting system for recessed lighting fixtures.

### SUMMARY OF THE INVENTION

More specifically, in accordance with the present invention, there is provided a light fixture for mounting into an opening defining a front surface and a rear surface, comprising a housing comprising side walls and at least one open end, the side walls comprising first and second apertures along a height thereof; and a hook comprising a main body, a first end part extending at a first angle relative to the main body and a second end part extending at a second angle relative to the main body; wherein the housing is adapted to be positioned inside the opening with the open end generally flush with the front surface of the opening; and the hook is adapted to be inserted into the housing from the inside of the housing by inserting the first end part through one of the first apertures and the second end part within one of the second apertures separated from the first aperture by the length of the main body between the first end part and the second end part, a free end of the first end part bearing on the rear surface of the opening, and a free end of the second end part bearing against an inner surface of the side walls within the housing.

There is further provided a hook for mounting a light fixture into an opening defining a front surface and a rear surface, comprising a main body; a first end part extending at a first angle relative to the main body; a second end part extending at a second angle relative to the main body at an opposite end of the main body; wherein the hook is adapted to be inserted into the light fixture from the inside of thereof by inserting the first end part through a first aperture in a sidewall of the light fixture and the second end part within a second aperture separated from the first aperture by the length of the main body between the first end part and the second end part, a free end of the first end part bearing on the rear surface of the opening and a free end of the second end part bearing against an inner surface of the side wall within the housing.

There is further provided a combination of a light fixture housing and a hook for mounting the light fixture into an opening defining a front surface and a rear surface, wherein the housing comprises sidewalls and at least one open end, the sidewalls comprising first and second apertures along a height thereof; wherein the hook comprises a main body, a first end part extending at a first angle relative to the main body and a second side part extending at a second angle relative to the main body; wherein the housing is positioned inside the opening with the open end directed toward the front surface of the opening; and the hook is inserted into the housing from the inside of the housing by inserting the first end part through one of the first apertures and the second end part within one of the second apertures separated from the first aperture by the length of the main body between the first end part and the second end part, a free end of the first end part bearing on the rear surface of the opening and a free end of the second end part bearing against an inner surface of the sidewalls within the housing.

There is further provided a method for mounting a light fixture into an opening defining a front surface and a rear surface, comprising: providing a housing comprising sidewalls with first and second apertures along a height thereof and at least one open end; positioning the housing within the opening with the open end generally flush with the front surface; providing a hook comprising a main body, a first end part extending at a first angle relative to the main body and a second side part extending at a second angle relative to the main body; inserting, from the inside of the housing, the first end part of the hook through one of the first apertures and the second end part of the hook within one of the second apertures separated from the first aperture by the length of the main body between the first end part and the second end part, a free end of the first end part bearing on the rear surface of the opening and a free end of the second end part bearing against an inner surface of the sidewalls within the housing, thereby securing the housing within the opening.

Other objects, advantages and features of the present invention will become more apparent upon reading of the following non-restrictive description of specific embodiments thereof, given by way of example only with reference to the accompanying drawings

### BRIEF DESCRIPTION OF THE DRAWINGS

In the appended drawings:

FIG. 1 is a first side view of a housing of a light fixture according to an embodiment of an aspect of the present invention;

FIG. 2 is a side view of a housing of a light fixture according to an embodiment of an aspect of the present invention;

FIG. 3 is a side view of a housing of a light fixture according to an embodiment of an aspect of the present invention;

FIG. 4 is a cut of section of a housing of a light fixture according to an embodiment of the present invention;

FIG. 5 is a perspective view of a light fixture according to an embodiment of the present invention;

FIG. 6 is a side view of the light fixture of FIG. 5;

FIG. 7 is a detail of FIG. 6;

FIG. 8 is a detail of FIG. 6;

FIG. 9A is a side perspective view of a hook according to an embodiment of an aspect of the present invention;

FIG. 9B is a front plan view of the hook of FIG. 9A prior to bending, i.e. as a flat metal sheet;

FIG. 9C is a side view of the hook of FIG. 9A;

FIGS. 10-13 show steps for securing a hook of a light fixture according to an embodiment of an aspect of the present invention; and

FIGS. 14-21 show steps for securing a hook of a light fixture according to another embodiment of an aspect of the present invention.

### DESCRIPTION OF EMBODIMENTS OF THE INVENTION

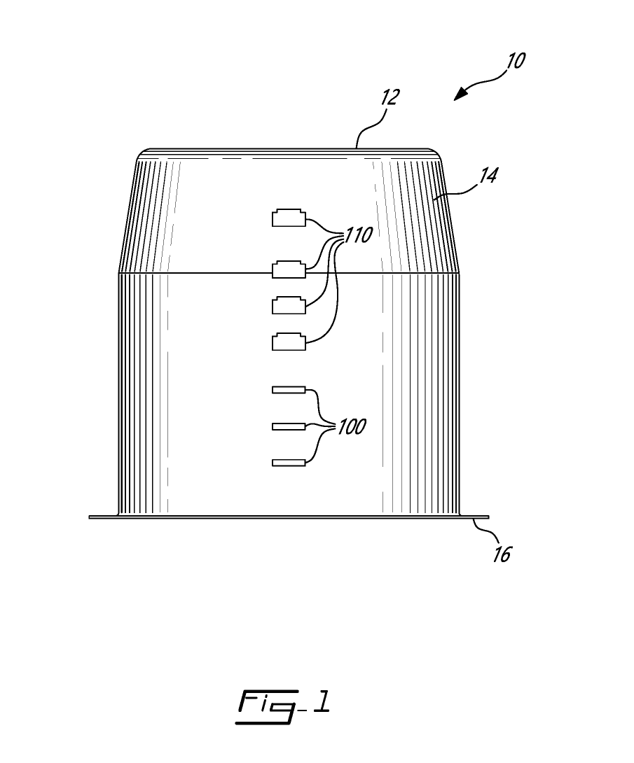

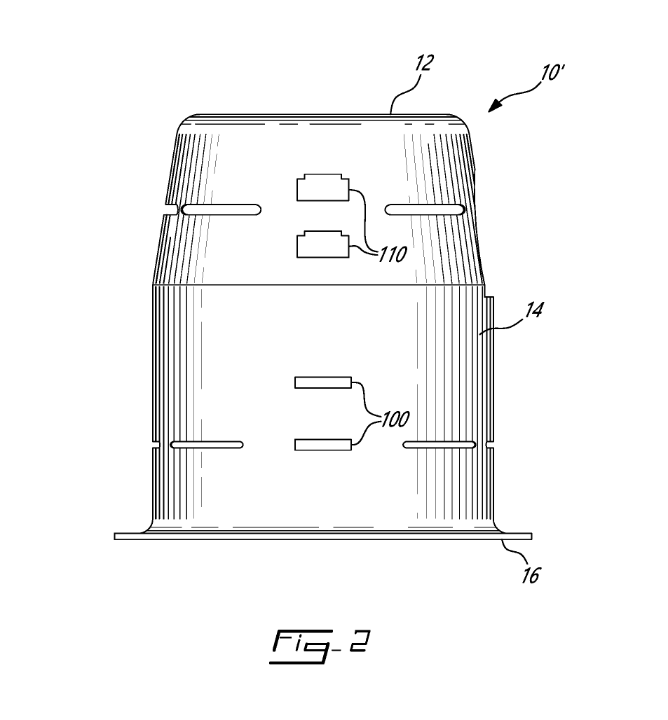

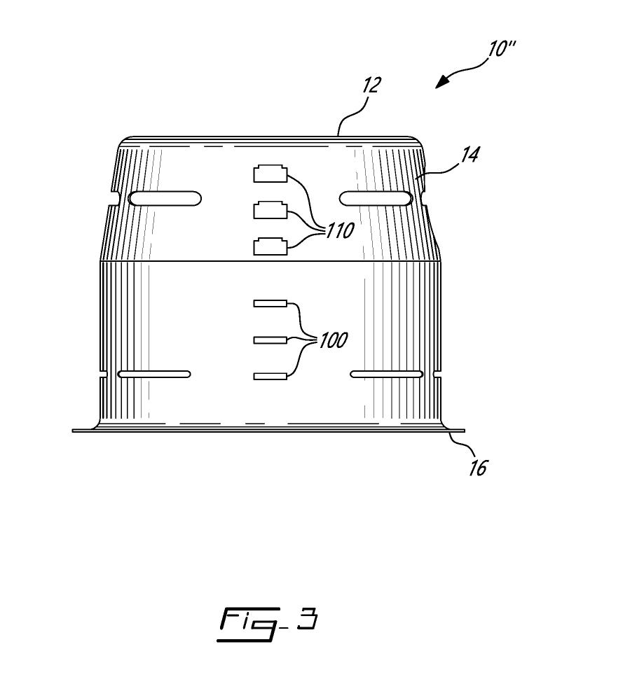

Referring to FIGS. 1-3, there are shown housings 10, 10′ and 10″ of a generally cylindrical shape, each having a sidewall 14 and optionally a bottom wall 12.

The sidewall 14 comprises, along the height of the housing, first apertures 100 located toward the open end of the housing and second apertures 110 generally aligned therewith upper away from the open end of the housing along the height of the housing, i.e. and located toward the bottom wall 12 of the housing in the examples illustrated herein. The number of first and second apertures may be varied depending on the height of the sidewall from the open end thereof to the opposite end thereof.

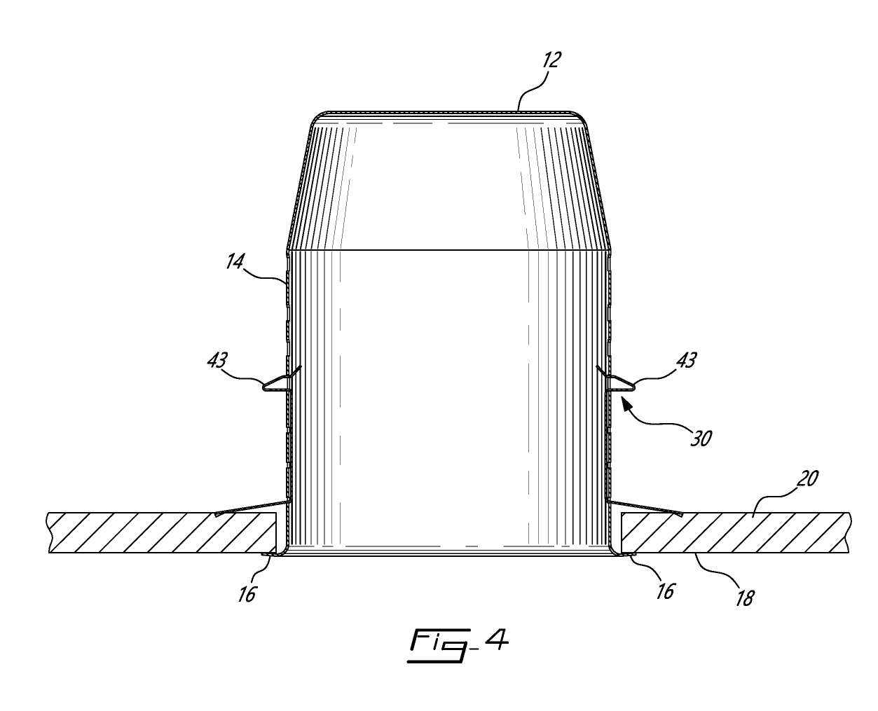

The sidewall 14 has an outer flange 16 surrounding at least part of the open end of the housing, which is adapted to bear against a front surface 18 of a ceiling or a wall 20, as best seen in FIG. 4, the open end being generally flush with the front surface of the opening.

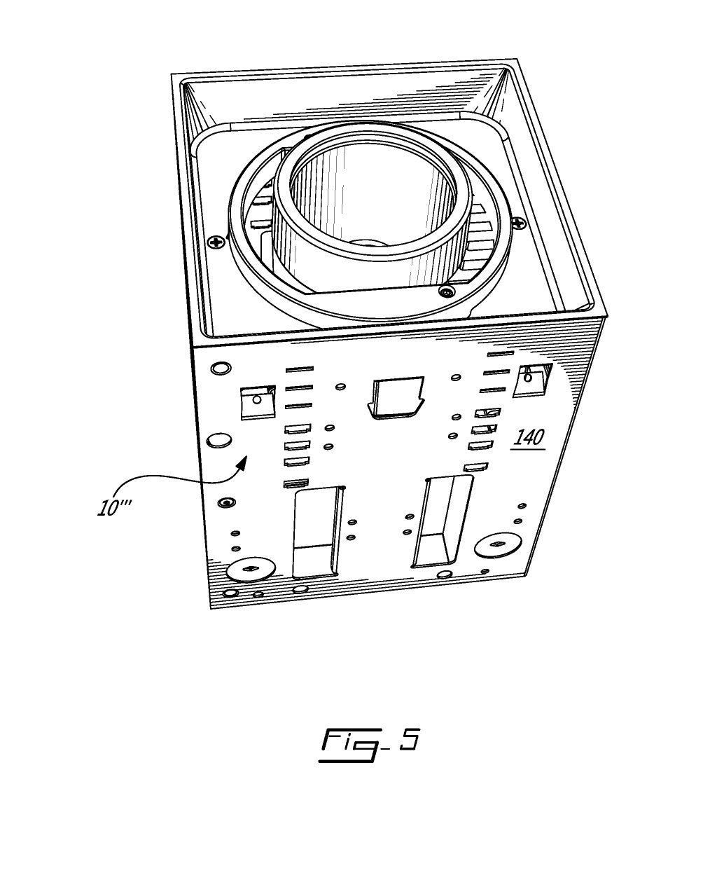

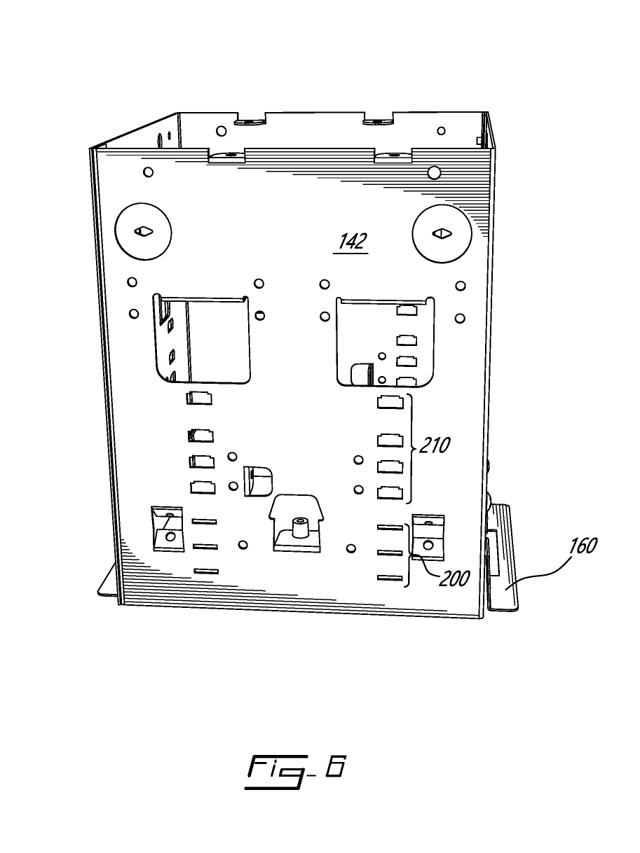

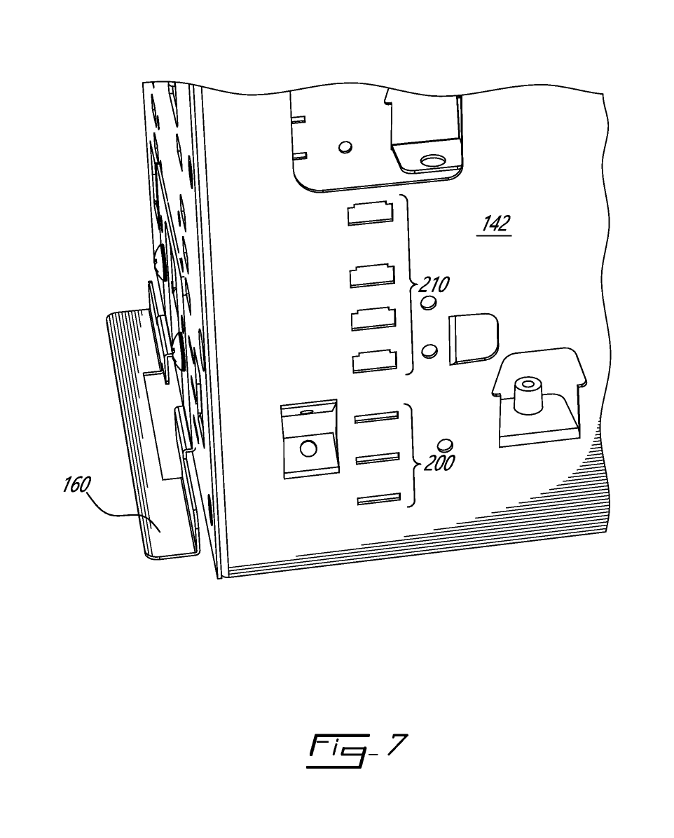

FIGS. 5-8 show a light fixture comprising a housing 10′″ of a generally parallelepiped shape, comprising opposite side walls 140, 142. The sidewalls comprise a series of first and second apertures 200, 210, the number of which depending on the height of the sidewalls. An outer flange 160 is provided on opposite side walls 140 for example, or on any one of the sidewalls of the housing 10′″.

The housing is made in a material such as steel, stainless steel or aluminum, or a plastic material for example.

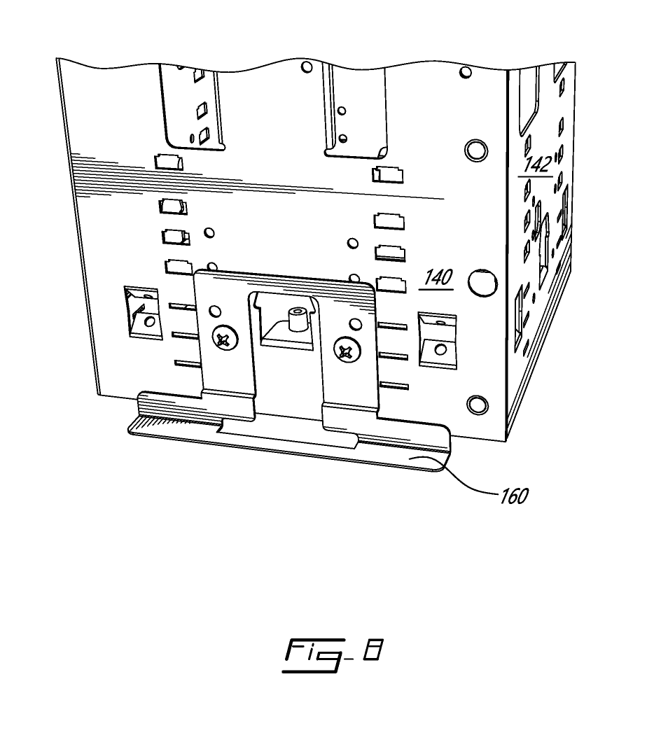

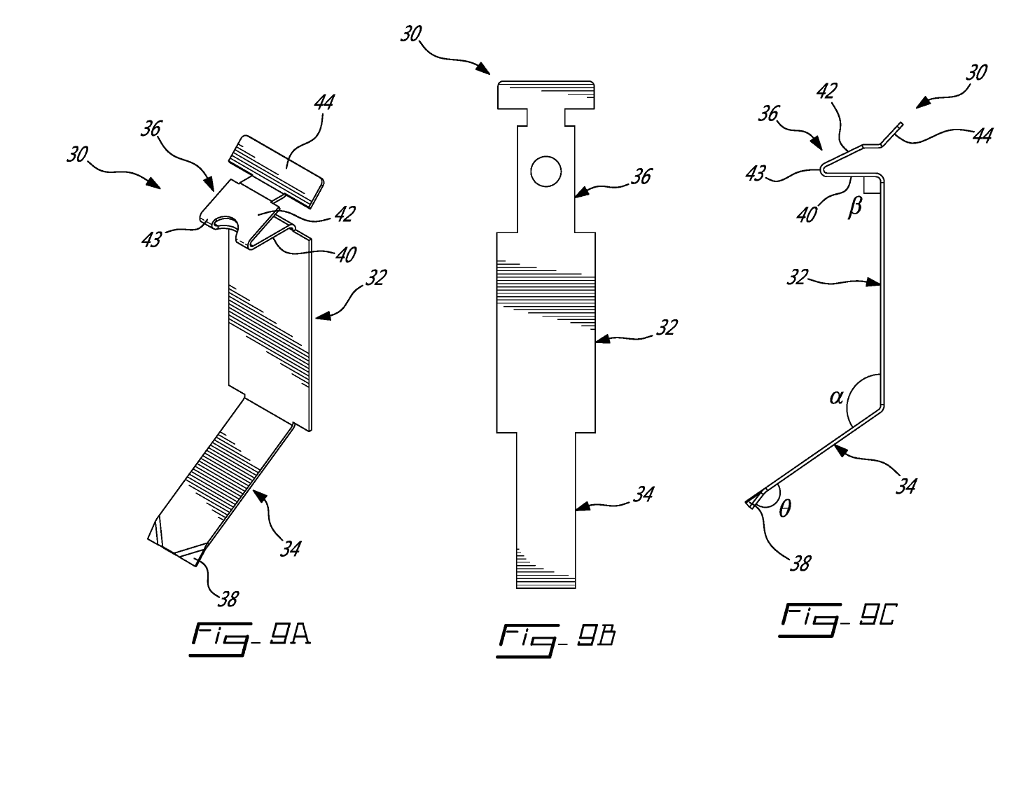

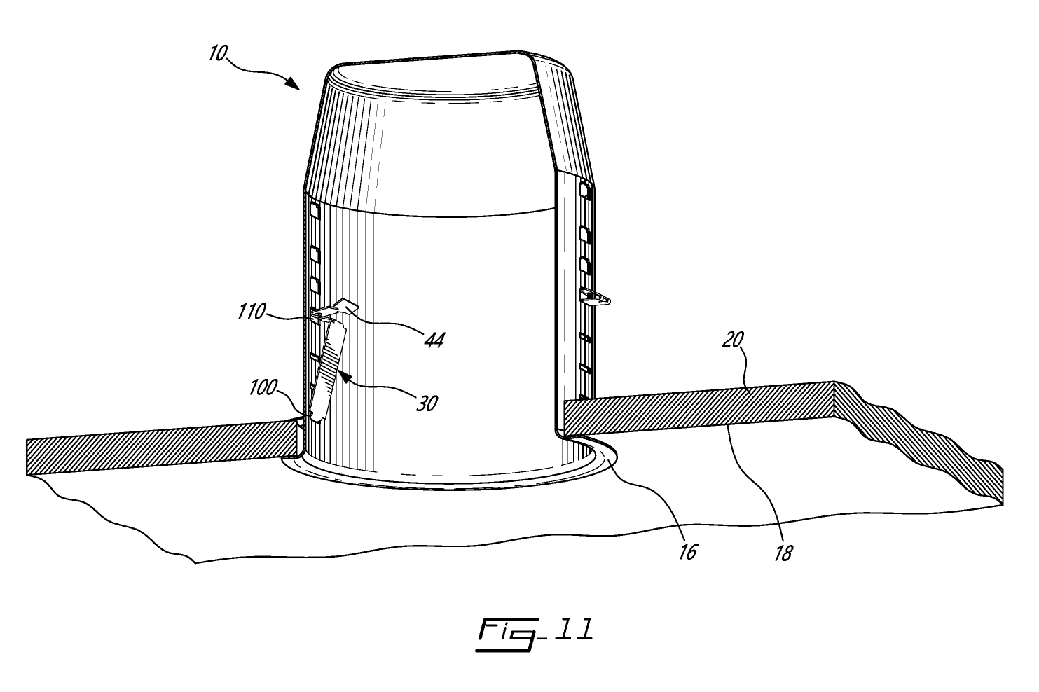

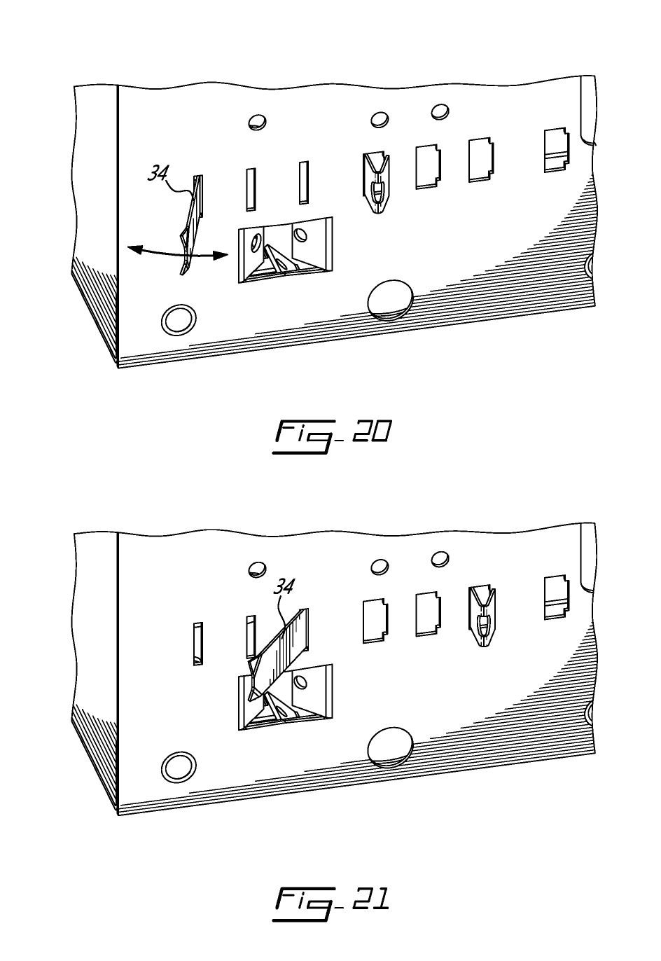

Referring to FIGS. 9, a hook, generally denoted 30, comprises a main body 32, a first end part 34 and a second end part 36, the first and the second end parts 34, 36 extending at an angle α and β respectively relative to the main body 32. As shown in FIG. 9B, the hook 30 is generally made of a plate of a material with bending properties as will be discussed hereinbelow in relation to FIGS. 11 and 20 for example, such as steel or stainless steel or aluminum or a plastic material

The free end 38 of the first end part 34 is slightly bent (see angle θ for example FIG. 9C).

The second end part 36 is at an angle β of about 90° with the main body 32, and comprises a first portion 40, followed by a second portion 42 folded together, and ending in a bent portion 44 (see angle μ FIG. 9C).

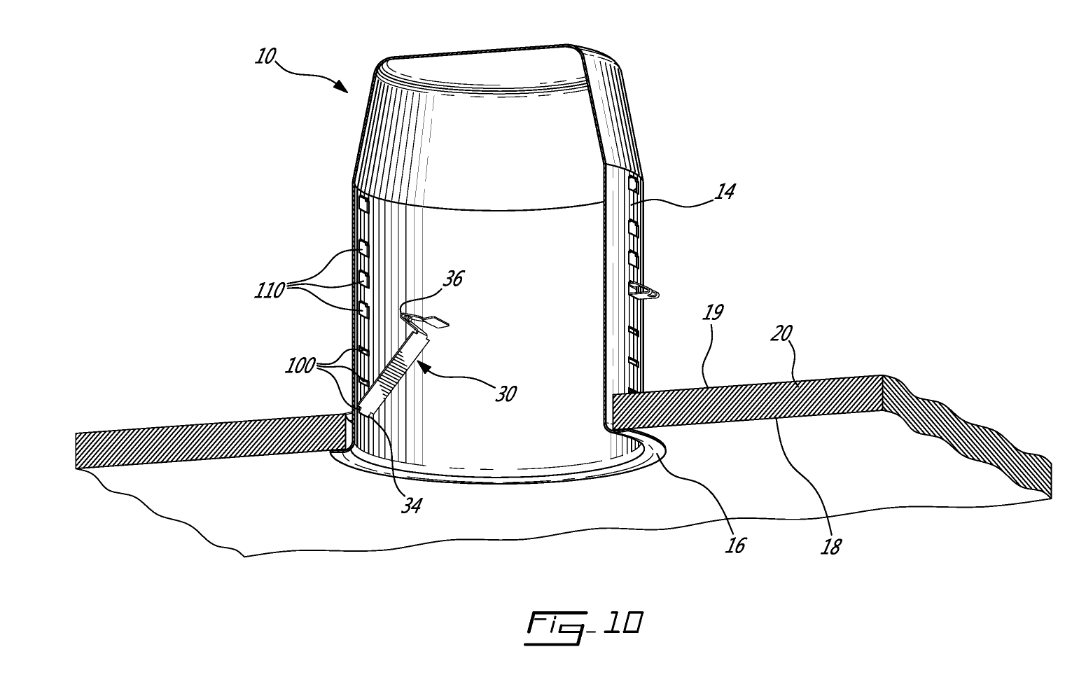

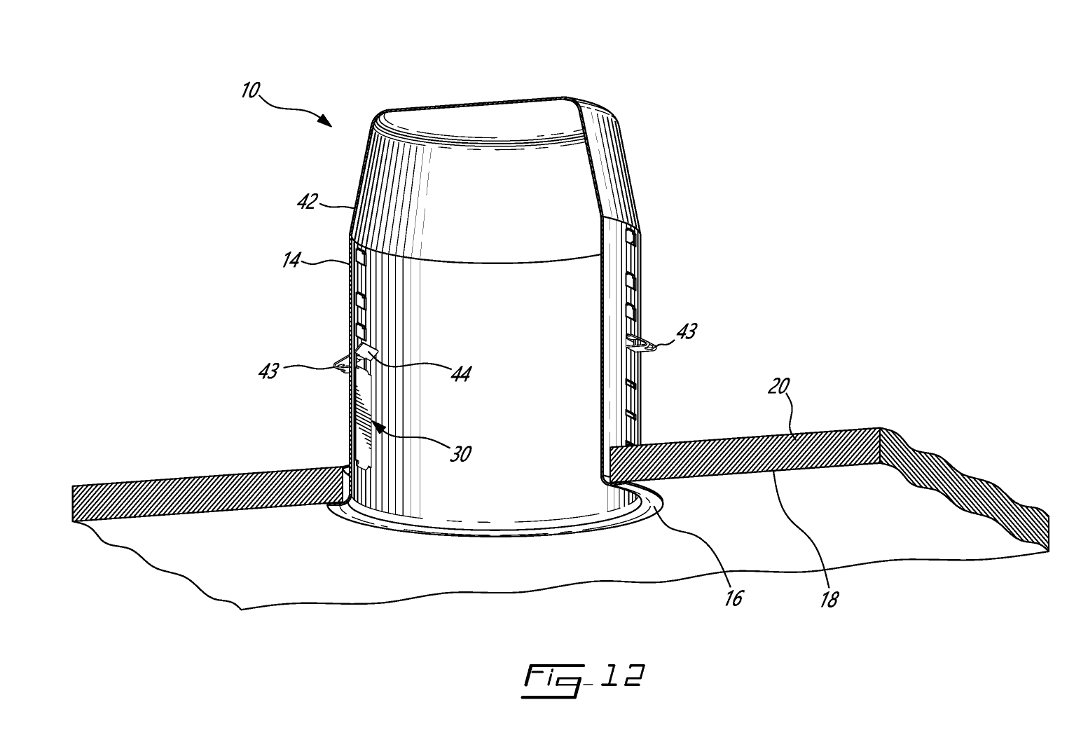

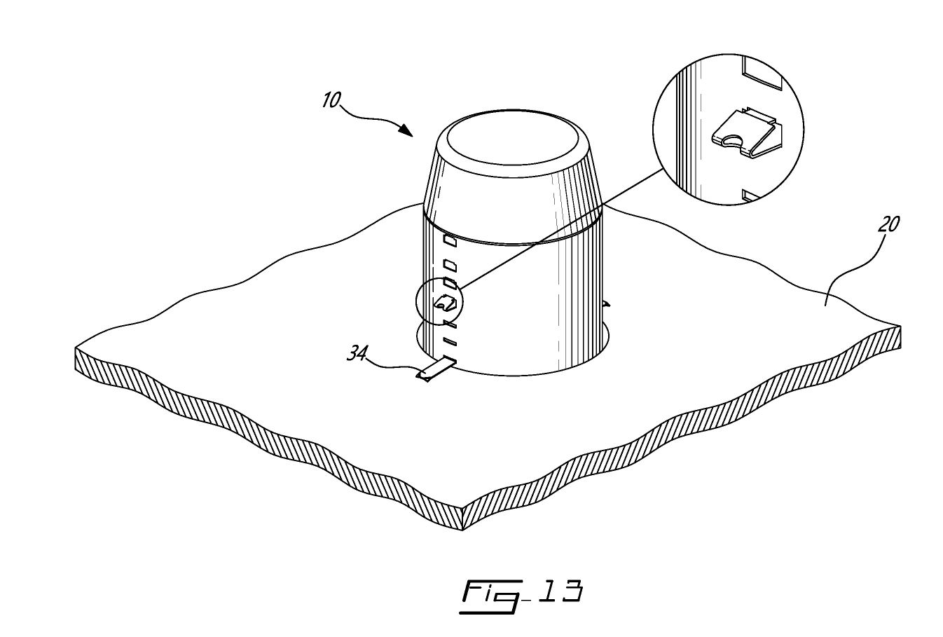

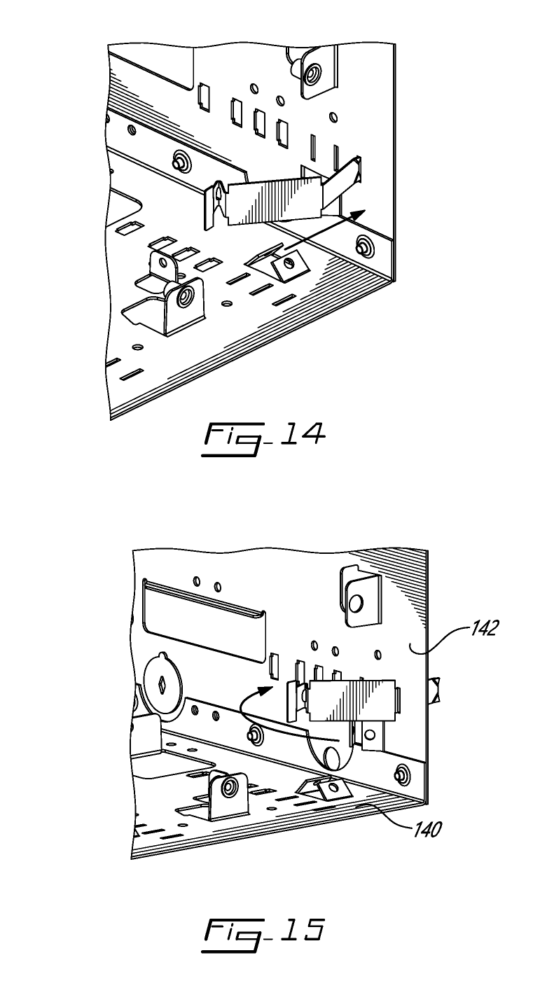

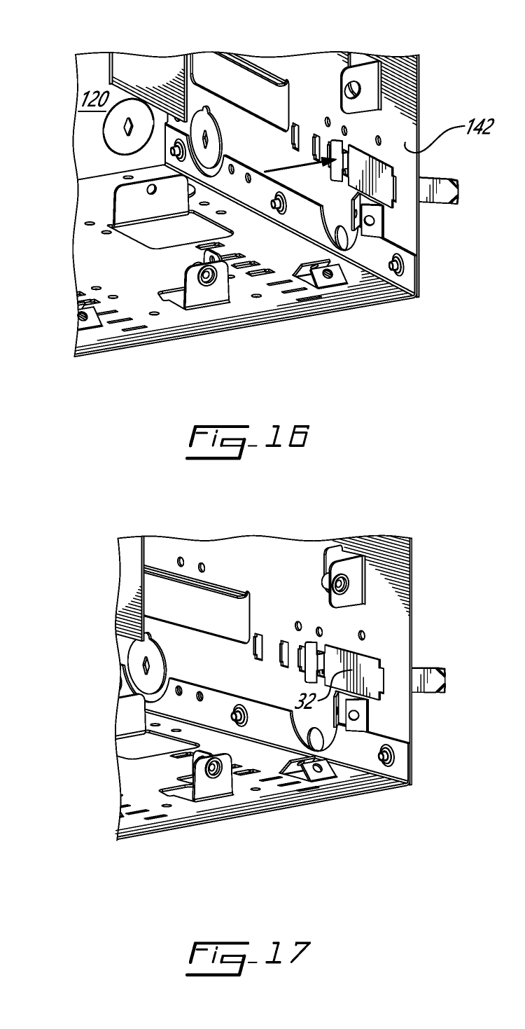

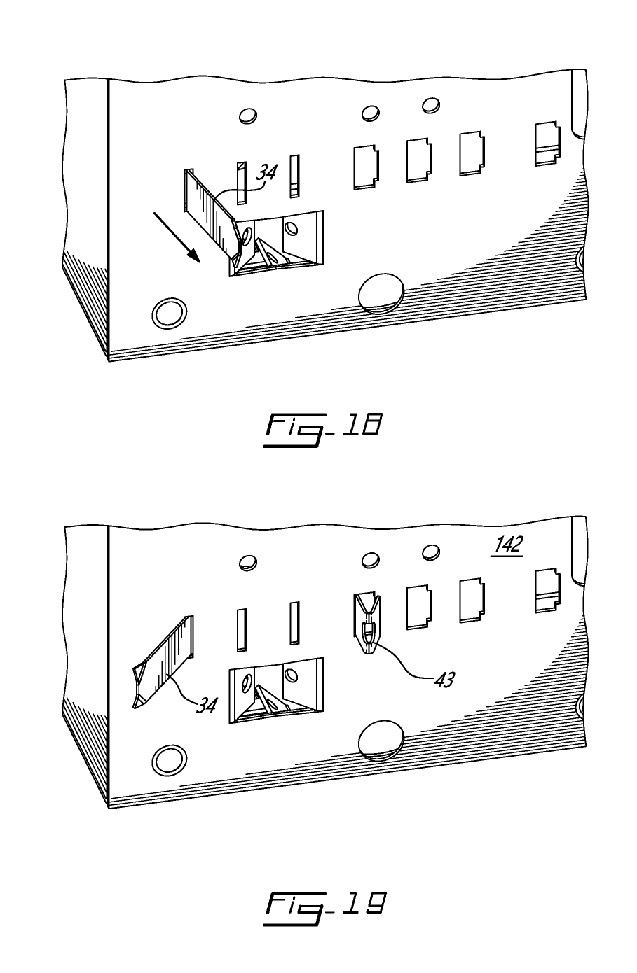

To secure the housing into an opening in the ceiling or wall 20 or other partition, once the housing is positioned inside the opening, the hook 30 is inserted into the housing from the inside of the housing by inserting the first end part 34 through one of apertures 100, 200 located nearest the open end of the housing, as shown in FIGS. 10 to 13 and in FIGS. 14 to 21. Then the folded end part 36 is inserted within one of apertures 110, 210 upper along the height of the housing (see FIG. 11), separated from the previously selected aperture 100, 200 by a distance corresponding to the length of the main body 32 between the first end part 34 and the second end part 36 (see FIGS. 13, 17 for example), the apex 43 between the first portion 40 and the second portion 42 of the folded end part 36 emerging on the outer surface of the side wall 14, 142 (see FIGS. 12, 13, 19). As best seen in FIG. 4, the apex 43 between the first portion 40 and the second portion 42 inserts in the aperture 110, 210 creating a flexion between first portion 40 and the second portion 42 in the apex 43 area. The second portion 42 may comprises notches, one of these notches matching the top of the aperture 110, 210 resulting in a snap fit between the hook 30 and the side wall 14 so that the hook cannot be pulled out of the apertures 110, 210 without compression of the free end 44 of the second end portion 36 (see FIG. 16). No tool is required.

As seen in FIGS. 4 or 11, the free end 38 of the first end part 34 of the hook 30 comes into abutment with the rear surface 19, i.e. hidden within the opening, of the ceiling or wall 20, and then the hook 30 bends for engagement of the second end part 36 of the hook 30 with the second opening 110, 210 in the wall of the housing. The bent portion 44 of the second portion 42, bearing against an inner surface of the side walls within the housing, maintains the hook 30 in position (see FIG. 12 for example). The housing is thus fixedly secured to the ceiling or wall 20 within the opening without clearance.

No tool is required and the hook can be clipped by hand in the inside of housing.

Once the hook is thus secured to the housing, the first end part 34 applies a force on the rear surface 19, i.e. non apparent side, of the ceiling or wall 20 (see FIG. 13), which tends to hold the fixture upwards. On the front surface 18, i.e. on the opposite visible side, of the ceiling or wall 20, the peripheral outer flange 16 of cylindrical housings as illustrated in FIG. 4, or the foot support 160 of the parallelepiped housing or housing 10′, bears against the surface 18 of the ceiling or wall 20, balancing the upward force submitted to the housing by the hook.

As can be seen for example in FIGS. 12 and 13, once thus snapped into place within the housing, the main body of the hook lies generally flat against the inner side wall of the housing.

The hook 30 can be deformed by bending the first end part 34, emerging on the outer surface of the side wall 142, toward the apex 43 also emerging on the outer surface of the side wall 142, as shown in FIG. 20, thereby generating a pressure behind the ceiling material (surface rear 19), so that the outer flange 16 of cylindrical housings (see FIGS. 1-3), or the outer flange 160 of parallelepiped housings (see FIGS. 6-8) abuts the ceiling material 18.

As people in the art would appreciate, the number of hooks used to secure a given light fixture may vary depending on the size of the housing and its shape.

The hook can be easily removed from the housing by hand, from the inside of the housing.

As shown in FIG. 21, the hook can be positioned at different positions along the height of the sidewall of the housing, by using different pairs of first and second apertures 200, 210 (100, 110 in FIGS. 1-3), thereby allowing accommodating a range of thickness of ceiling or wall or partition 20.

As people in the art would appreciate, open housings, i.e. without bottom wall, can be used.

Although the present invention has been described hereinabove by way of embodiments thereof, it may be modified, without departing from the nature and teachings of the subject invention as described herein.

What is claimed is:

1. A light fixture for mounting into an opening defining a front surface and a rear surface, comprising:
a housing comprising side walls and at least one open end, said side walls comprising first and second apertures along a height thereof; and
a hook comprising a main body, a first end part extending at a first angle relative to the main body and a second end part extending at a second angle relative to the main body;
wherein said housing is adapted to be positioned inside the opening with said open end generally flush with the front surface of the opening; and
said hook is adapted to be inserted into the housing from the inside of the housing by inserting the first end part through one of said first apertures and the second end part within one of said second apertures, said second aperture being separated from said first aperture by the length of the main body between the first end part and the second end part, a free end of the first end part bearing on the rear surface of the opening, and a free end of said second end part bearing against an inner surface of said side walls within said housing.

2. The light fixture of claim 1, wherein said open end comprises an outer flange, and said housing is adapted to be positioned inside the opening with said outer flange bearing against the front surface of the opening.

3. The light fixture of claim 1, wherein the free end of said first end part of the hook is bent.

4. The light fixture of claim 1, wherein said second end part comprises a first portion and a second portion folded together and defining an apex.

5. The light fixture of claim 1, wherein a free end of said second end part is bent.

6. The light fixture of claim 1, wherein said first and said second apertures are aligned along the height of the housing.

7. The light fixture of claim 1, wherein said housing is of a generally parallelepiped shape comprising opposite side walls.

8. The light fixture of claim 1, wherein said housing is of a generally cylindrical shape.

9. The light fixture of claim 1, wherein said housing is made in one of steel, stainless steel and aluminum.

10. The light fixture of claim 1, wherein said hook is made in one of steel, stainless steel and aluminum.

11. A hook for mounting a light fixture into an opening defining a front surface and a rear surface, comprising:
a main body;
a first end part extending at a first angle relative to the main body;
a second end part extending at a second angle relative to the main body at an opposite end of said main body;
wherein said hook is adapted to be inserted into said light fixture from the inside of thereof by inserting said first end part through a first aperture in a sidewall of said light fixture and the second end part within a second aperture in the sidewall of said light fixture, said second aperture being separated from said first aperture by the length of said main body between the first end part and the second end part, a free end of the first end part bearing on the rear surface of the opening and a free end of said second end part bearing against an inner surface of said side wall within said housing.

12. A combination of a light fixture housing and a hook for mounting the light fixture into an opening defining a front surface and a rear surface,
wherein said housing comprises sidewalls and at least one open end, said sidewalls comprising first and second apertures along a height thereof;
wherein said hook comprises a main body, a first end part extending at a first angle relative to the main body and a second side part extending at a second angle relative to the main body;
wherein said housing is positioned inside the opening with said open end directed toward the front surface of the opening; and
said hook is inserted into the housing from the inside of the housing by inserting the first end part through one of said first apertures and the second end part within one of said second apertures, said second aperture being separated from said first aperture by the length of the main body between the first end part and the second end part, a free end of the first end part bearing on the rear surface of the opening and a free end of said second end part bearing against an inner surface of said sidewalls within said housing.

13. A method for mounting a light fixture into an opening defining a front surface and a rear surface, comprising:
providing a housing comprising sidewalls with first and second apertures along a height thereof and at least one open end;
positioning the housing within the opening with the open end generally flush with the front surface;
providing a hook comprising a main body, a first end part extending at a first angle relative to the main body and a second side part extending at a second angle relative to the main body;
inserting, from the inside of the housing, the first end part of the hook through one of the first apertures and the second end part of the hook within one of the second apertures separated from the first aperture by the length of the main body between the first end part and the second end part, a free end of the first end part bearing on the rear surface of the opening and a free end of the second end part bearing against an inner surface of the sidewalls within the housing, thereby securing the housing within the opening.
